(19) United States
(12) Patent Application Publication
(10) Pub. No.: US 2005/0145721 A1
(43) Pub. Date: Jul. 7, 2005

(54) Microdot application method and system

(76) Inventors: Brent D. McLaws, Spokane, WA (US); Ian P. Allen, Sydney (AU)

Correspondence Address: WELLS ST. JOHN P.S., 601 W. FIRST AVENUE, SUITE 1300, SPOKANE, WA, 99201, US

(21) Appl. No.: 10/980,611

(22) Filed: Nov. 2, 2004

Related U.S. Application Data
(63) Continuation-in-part of application No. 09/715,864, filed on Nov. 17, 2000, now abandoned.

(51) Int. Cl. B05D 5/00

(52) U.S. Cl. 239/317; 427/256; 239/8; 239/10; 239/328

(57) ABSTRACT

Disclosed is an invention relating to the application of microdots to an article to provide identification of that article, for example in the event of theft. This may relate to the application of identifying microdots to a vehicle such as an automobile, truck, motorcycle, boat, or jet ski. Also disclosed is an application system for identifier labels which is particularly useful in applying identifier labels to articles or products such as vehicles. In embodiments of this invention, a dynamic fluid such as provided by compressed air is utilized to apply a mixture of identifier labels and a base fluid, such as an adhesive or paint, to an article. In further embodiments, the dynamic fluid is also utilized to assist in the mixing of the mixture.

### RELATED APPLICATIONS

This application is a continuation-in-part of U.S. patent application Ser. No. 09/715,864, filed Nov. 17, 2000; currently pending or co-pending, entitled “IDENTIFIER LABEL APPLICATION SYSTEM” by the same inventors, namely, Brent D. McLaws and Ian P. Allen; and hereby claims the benefit of said application.

### TECHNICAL FIELD

This invention pertains to a system for applying identifier labels, particles or micro-identification indicia, to articles or products. The present invention also relates to the application of microdots to an article to provide identification of that article, for example in the event of theft. More particularly, but not exclusively, the invention relates to the application of identifying microdots to a vehicle such as an automobile, truck, motorcycle, boat, or jet ski.

### BACKGROUND OF THE INVENTION

In many applications of product control and tracking, it is desirable to apply an identifier label, identifier particle, microdot or identifying indicia to various articles, including to products. The identifier labels or indicia are generally useful in or utilized to later identify the article(s) to which the indicia are applied or affixed.

The application of identifying microdots to a vehicle for identification purposes is known. A batch of microdots encoded with identifying data discrete to that particular vehicle and each readable by the eye under magnification, is applied to the vehicle in a number of different places using a strong adhesive. In the event of theft, although an attempt may be made to remove identifying microdots, due to their very small size and large number, at least several thousand per vehicle, it is unlikely that all of the microdots will ever be able to be removed so it is likely that there will always be some microdots remaining on different parts of the vehicle for subsequent identification.

It is desirable to provide a simple and inexpensive system for applying the microdots. Further, it is important that the contamination of microdots between successive batches is completely avoided.

There are situations where it is desirable to apply the identifier labels or indicia by generally applying them to the article, such as by spraying or by applying a plurality of the identifier labels or indicia generally such that there are too many applied to readily or easily remove them.

It is also desirable to provide an application system in which the same components or parts are not exposed to multiple different identifier labels because it may be difficult to clean or remove all the particles from one application before the next application is commenced.

It is therefore an objective of this invention to provide a new identifier label application system.

### BRIEF DESCRIPTION OF THE DRAWINGS

Preferred embodiments of the invention are described below with reference to the accompanying drawings, which are briefly described below.

FIG. 1 is a partial cross-sectional elevation view of one embodiment of a system contemplated by this invention;

FIG. 2 is a partial cross-sectional elevation view of another embodiment of an application system as contemplated by this invention, which is portable and includes a portable source of dynamic fluid;

FIG. 3 is an elevation view of another embodiment of a system contemplated by the invention, illustrating a pressurized container which contains a pressurized mixture of identifier labels and a base fluid; and

FIG. 4 is a perspective view of one possible article, a vehicle, which this invention may be used to place identifier labels on.

FIG. 5 is an exploded elevation view of another embodiment of the invention; and

FIG. 6 is a cross section view from the embodiment of the invention illustrated in FIG. 5 when the two components are interconnected.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

The term identifier label includes identifiers, identifier labels, identifier particles and identifying indicia, and as used herein is not limited to any specific one type of particle, label or identifier, but instead is each meant to include all unique identifiers, identifier particles and identifiable labels, including without limitation, micro-labels, DNA identifiers, synthetic DNA labels, biological elements, rare earth minerals utilized for tracing (such as those minerals and services offered by Austguard of Perth Australia), UV detectable particles or substances, micro dots, data dots, unique or identifiable chemical compounds and others.

The term dynamic fluid as used herein may be, without limitation, any one of a number of gases, or liquid fluids, foams, and others, with no one in particular being required to practice this invention, and with air being the preferred dynamic fluid. An aerosol or air and aerosol combination may be utilized for a portable embodiment of the invention.

The term base fluid as used herein means any substance or material that is mixed with or contains the identifier labels, and which may be discharged with the identifier labels. The base fluid may inherently include or contain the identifier labels. The base fluid may even be solid or semi-solid prior to use, and additives or heat may be added to allow it to be discharged as desired. This may require heating, adding a solvent or some other means to cause it to go to a fluid state. This invention also contemplates a number of different relative proportions of identifier labels and base fluid with no specific proportion or range of proportions being required to practice this invention. Examples of base fluids, without limitation, are adhesives, paints, polymers, foam, undercoatings for application to vehicles, to name just a few.

The term microdot is one known and used in the industry, and known to those of ordinary skill in the industry. Microdots may be any one of a number of different shapes and fall within a range of sizes, within the scope or contemplation of this invention. Identification information or indicia is typically contained on the microdots, or contained or inherent in or on the microdot, depending on the intended application of the microdots. A predetermined microdot is one with a known identifier to associate with whatever the microdot or identifier is to be applied to.

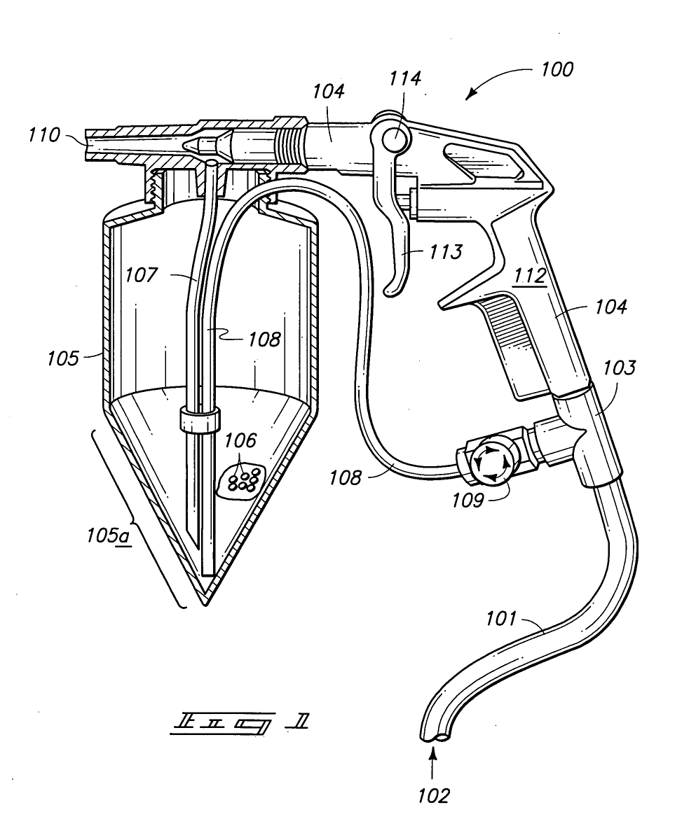

FIG. 1 is a partial cross-sectional elevation view of one embodiment of a container and an application system contemplated by this invention, illustrating a dynamic fluid input hose 101 through which dynamic fluid 102 may flow, conduit 103, framework 104, container 105, identifier labels 106, discharge feed conduit 107, dynamic fluid conduit 108, valve 109, and discharge aperture 110.

In the embodiment of the invention illustrated in FIG. 1, the applicator 100 has a handle area 112, a trigger 113 is pivotally mounted to the framework 104 about axis 114, and is utilized to actuate the flow of compressed fluid, preferably air, through input hose 101. While a trigger is shown, any one of a number of known activation devices or release mechanisms may be used within the contemplation of this invention.

Conduit 103 is a tee which allows the air to pass to and through framework 104 as well as through valve 109. The valve 109 controls the flow of the dynamic fluid through conduit 108 which is routed into the container 105 and positioned such that the dynamic fluid is delivered to a position within the container such that the identifier labels 106 are mixed with the base fluid.

In this embodiment of the invention, the dynamic fluid may also be utilized to agitate, mix and continue to mix, the base fluid and the identifier labels 106. In this embodiment it is preferable that the container be configured such that the dynamic fluid is delivered within the container and within the mixture to create or maintain a better mixture.

A conical or cone shaped bottom portion 105a of the container 105 has been found as one of numerous possible shapes or configurations which facilitates a desired mixing. Other shapes wherein there is a smaller cross section at lower section may also achieve desired mixing results in some embodiments, however, no particular configuration of the container 105 or bottom portion 105a of the container is required to practice this invention, nor is it required to have a smaller cross section at a lower section. Therefore container shapes such as cylindrical, boxes and others may also be used within the contemplation of this invention.

The container 105 within the contemplation of this invention may also be made of any particular material, which may render the container collapsible, expandable, folding, rigid or semi-rigid, to name a few examples. For example and without limitation, the container 105 may be made of a rigid steel or polymer or of flexible, collapsible material such as coated organic products such as milk cartons which may be folded and unfolded, bladder type bags (such as polymer or polyester) which collapse, as well as numerous other possibilities.

It will also be noted by those of ordinary skill in the art that the container 105 need not be located below the discharge aperture 110, but instead may be positioned above it or at any angle in between. In an embodiment in which the container 105 is located above the discharge aperture 110, gravity may be partially or wholly used in feeding the identifier labels, mixture and/or solution to the discharge aperture 110.

The container 105 in this embodiment is actually in two pieces, an upper and a lower, with the two attaching by threaded joint (as is evident from the drawing). However this invention is not limited to any specific number of pieces or ways of integrating or attaching the same.

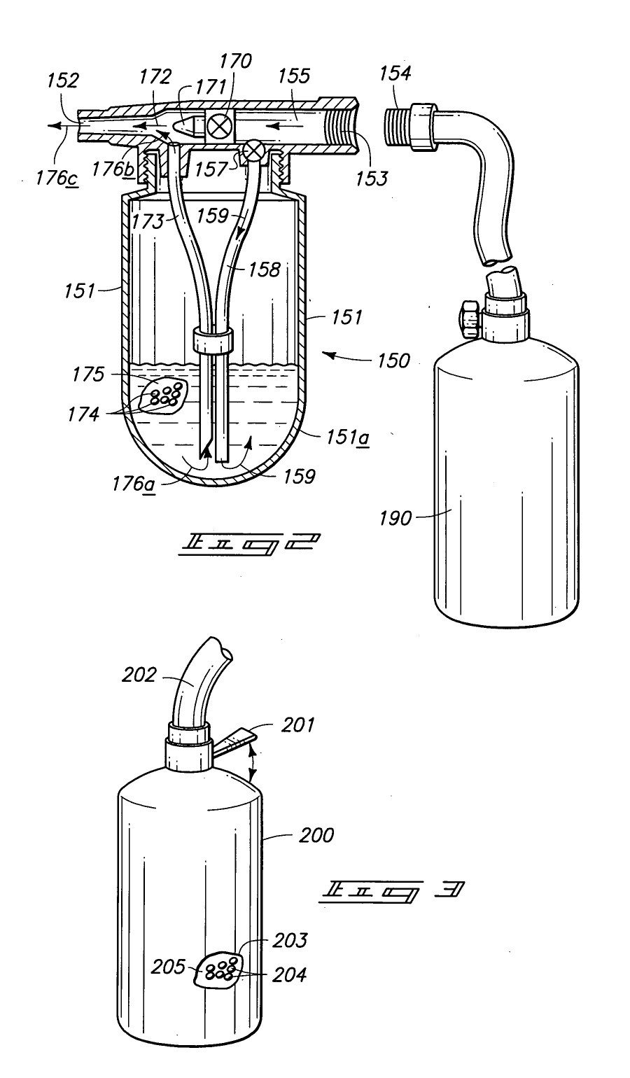

FIG. 2 is a cross-sectional view of another example of an embodiment of this invention, illustrating a more self contained embodiment of an applicator 150, which only requires a source of a dynamic fluid (in this embodiment, compressed air). FIG. 2 illustrates container 151 with a hemispherical bottom portion 151a, with a mixture 176a of identifier labels 174 and base liquid 175. The mixture 176 may be prepackaged or the base fluid 175 may be later added.

A compressed air conduit 154 provides the source of dynamic fluid and compressed air conduit 154 attaches to the applicator 150 at input aperture 153. Discharge valve 170 controls the flow of the compressed air through discharge nozzle 171 and to discharge aperture 152. The dynamic fluid exiting the nozzle 171 is represented by arrow 172. It should also be noted that nozzle 171 may be preferred but not necessary as discharge valve 170 may be all that is utilized, all within the contemplation and scope of this invention.

Valve 157 controls the flow of the compressed air 159 through conduit 158 and into the mixture 176 of identifier labels 174 and base fluid 175, and provides an agitation or mixing of the identifier labels 174 with the base fluid 175.

As discharge valve 170 is opened, compressed air flows out discharge aperture 152 and draws the mixture 176 through conduit 173 and into the discharge aperture 152. The mixture 176b provided to the discharge aperture is shown, as is the mixture 176c exiting the discharge aperture 152.

Framework 156 may be one piece with the container, it may be integral or even positioned relative to it. Input chamber 155 receives the dynamic fluid and facilitates its flow to discharge valve 170 and valve 157, both of which may be any one of a number of different types of valves which are well known and which would depend on the dynamic fluid chosen and the valving control desired.

The discharged mixture 176c may be atomized or it may just be drawn or pushed out the discharge aperture 152, all within the contemplation of this invention. Furthermore, this invention contemplates mixtures wherein the identifier labels are already sufficiently contained within the material or substance such that there is no need for mixing by any means, including with the introduction of a dynamic fluid such as compressed air. The term “mixture” therefore also or additionally includes substances, fluids, etc. wherein the identification characteristics are inherent in the base fluid and no combining or mixing is required. There are embodiments in which only a solvent is added to provide the flow characteristics desired.

As this application is utilized, one identifier label may be used for one production facility, or one particular identifier label may be used for each separate article produced, such as for one vehicle.

FIG. 2 also illustrates another embodiment or feature which is a more portable system wherein the source of dynamic fluid is an aerosol type of can or compressed fluid container 190 for example. In this embodiment, there are numerous possible gases and/or fluids which may be the dynamic fluid, with aerosols and foams merely being a few of the possible and readily available portable sources. The container 151 may be disposable.

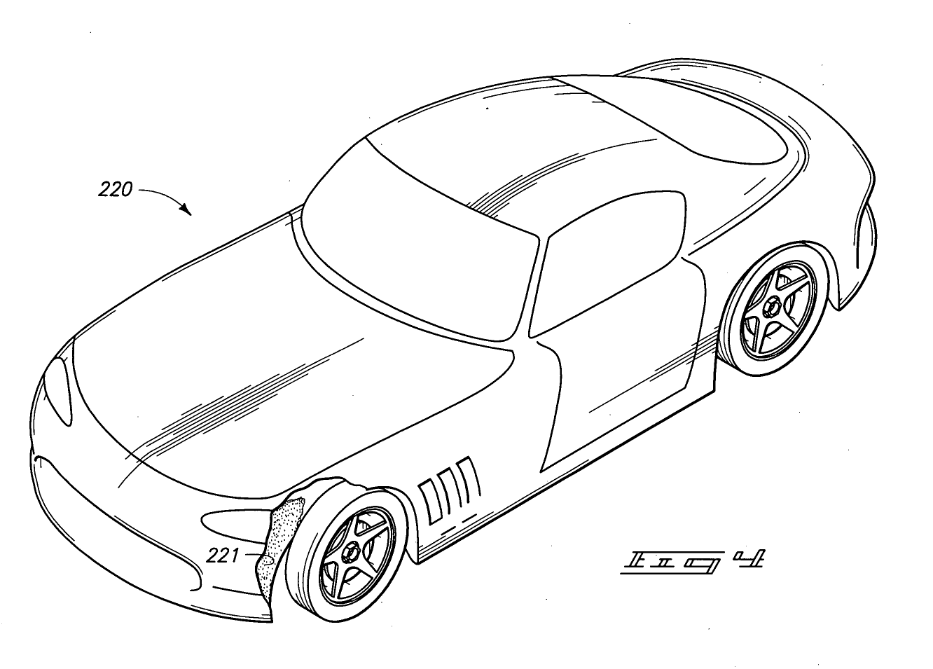

FIG. 3 illustrates another embodiment contemplated by the invention, showing a self contained portable and disposable system, illustrating a container 200, a discharge conduit, an activation lever 201, a mixture 203 of identifier labels 204 and base fluid 205. The mixture 203 is generally compressed or expandable and when the lever or activation device is activated, the mixture 203 is released through the discharge aperture and through whatever discharge conduit 202 is used for the specific application. The lever 201 activates a discharge valve which is in or near the discharge aperture. There are a number of different devices and mechanisms to valve and to actuate the release of the mixture, with no one in particular being required to practice this invention. The base fluid 205 may be any one of a number of different base fluids as stated above, such as an adhesive foam material. There are known containers with known valves for containing and releasing pressurized fluids and foams.

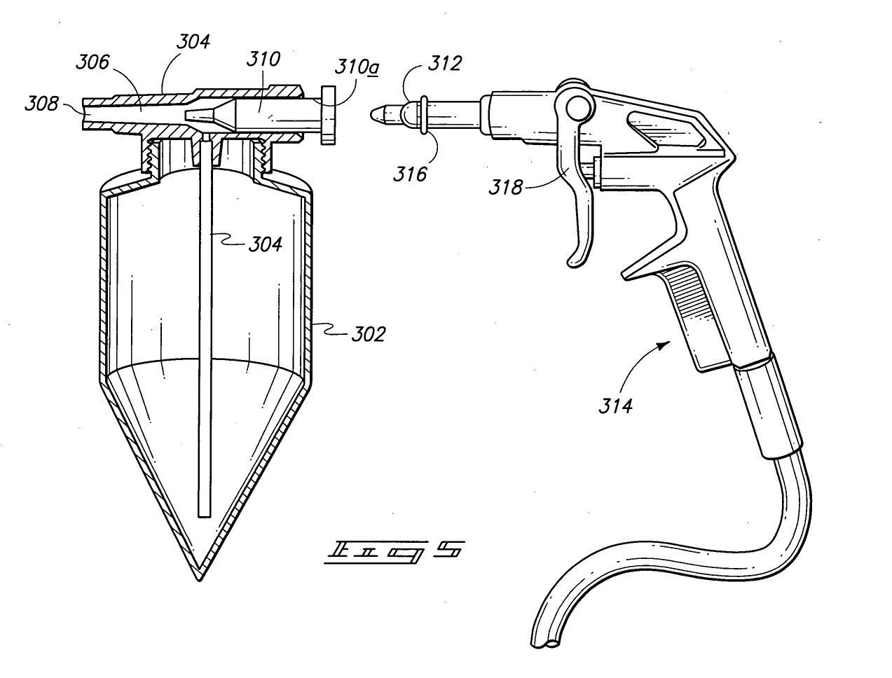

FIG. 4 illustrates one of the numerous possible articles on which identifier labels may be applied using the invention, namely an article or vehicle 220. FIG. 4 illustrates how or where a mixture 221 of identifier labels mixed with a base fluid such as an adhesive may be positioned or sprayed on the vehicle 220.

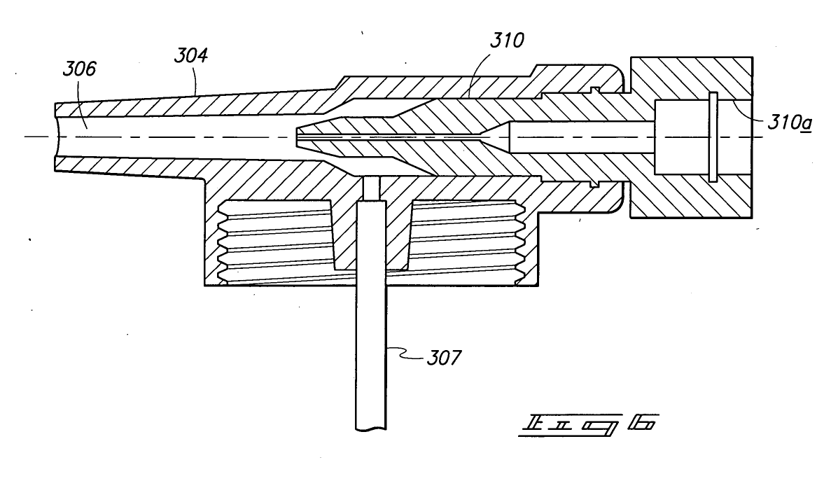

FIG. 5 shows the main components of an application system in accordance with the preferred embodiment of the invention and including a container for a microdot/adhesive mixture, a discharge part, and an air gun onto which the discharge part when fitted to the container is applied.

As shown in FIG. 5, the system comprises a disposable container 302 having a large number of microdots, for example ten thousand (10,000) for application to an automobile, and a viscous adhesive into which the microdots are mixed prior to application. The microdots carry indicia discrete to the particular article to which the microdots are to be applied and in the case of a vehicle that indicia is preferably the VIN which is a discrete, internationally recognized, identification code used by all major vehicle manufacturers. The adhesive itself preferably includes ultraviolet detectable particles or molecules to facilitate identification of the applied microdots under ultraviolet light. The container 302 has an opening at the upper end of the body, as shown a screw threaded opening, which is initially supplied with a closure cap, the cap being removed prior to use and replaced by a discharge part 304 which is screwed onto the container body in place of the cap. It is however to be understood that instead of using a cap and discharge part which screws onto the container body, a secure press-on or snap-on fitting with an appropriate sealing structure could alternatively be used.

The discharge part 304 is in the form of a one-piece plastics molding with a discharge passage 306 into which leads a tube 307 extending from the mixture within the body of the container 302 whereby the mixture is drawn into the passage 306 through the tube 307 for discharge via an outlet end 308 of nozzle-like form when air under pressure is fed through the passage 306. The air is fed into the discharge passage via a nozzle 310 which is a second plastics component of one-piece form which is fitted into the inlet end of the discharge passage 306. The nozzle 310 extends outwardly to terminate in an inlet fitting 310a which is mounted over the nozzle 12 of an air gun 314. In the form shown in FIG. 5, the nozzle 312 of the air gun 314 includes an O-ring 316 which seals within the inlet fitting 310a so that the nozzle 310 is sealingly and securely attached to the nozzle 312, but is removable therefrom. In the particular form shown, the nozzle 310 itself is a friction fit within the discharge passage 306 of the discharge part 304.

In use, to apply the microdots to a vehicle or other article, the lid is removed from the microdot container 302 and if the adhesive is not pre-supplied within the container it is added at that stage. The discharge part 304 with draw tube 307 is then applied to the upper end of the container body. The separate nozzle 310 may be pre-fitted into the discharge passage 306 in which case all that is then necessary is to mount the discharge part 304 with nozzle 310 over the outlet nozzle 312 of the air gun 314. Alternatively, the nozzle 310 can be first fitted onto the outlet nozzle 312 and then fitted into the discharge passage 306. By operating the trigger 318 of the gun which opens and closes an air control valve, air is fed via the nozzle 310 into the discharge passage 306 to thereby cause the mixture to be drawn from within the container via the draw tube 307 for discharge through the outlet end 308 of the discharge passage 306 and hence for application to the vehicle.

When the microdot/adhesive mixture has been discharged from the container 302, the nozzle 310 together with the discharge part 304 and container 2 is removed from the outlet nozzle 312 of the gun 314 and disposed. It will be readily understood that since the nozzle 312 of the gun is isolated by means of the nozzle 310 from contacting the microdot/adhesive mixture during discharge, the gun nozzle 312 will remain free from contamination and will therefore not require any cleaning for successive uses.

FIG. 6 shows an alternative form of discharge part. FIG. 6 shows a modified version in which the nozzle 310 is snap-fitted into the discharge passage 306 and has at its outer end an inlet fitting 310a for releasable snap-fitting over a complementary formation on the nozzle part of the air gun.

Microdots as identifier labels are applied to an article drawing a mixture of microdots and adhesive from a container 302 using pressurized air. A discharge part 304 is coupled to the container 302 and has a passage 306 with an inlet portion and a discharge outlet 308. A nozzle 310 separately formed from the discharge part 304 is fitted into the passage 306 in the discharge part 304; the nozzle 310 is fitted onto an outlet component 314 of a system for supplying air under pressure.

Air fed under pressure via the nozzle 310 and into the passage 306 draws the mixture from the container body into the passage 306 for discharge through the discharge part 304 for application to the article. After use the nozzle 310 is removed from the outlet component 314 of the air supply system and the container 302, the discharge part 304, and the nozzle 310 are then discarded. Accordingly the outlet component 314 of the air supply system remains free from any contamination with the microdot/adhesive mixture and can thereby be used for a subsequent application without the need to clean it.

As will be appreciated by those of reasonable skill in the art, there are numerous embodiments to this invention, and variations of elements and components which may be used, all within the scope of this invention.

One embodiment of this invention for example involves an identifier label container for use in combination with a source of dynamic fluid which provides a force to apply identifier labels to an article, the container comprising: a container with a plurality of predetermined identifier labels therein; a discharge aperture in fluid communication with the container; and a fluid intake aperture configured to receive the source of dynamic fluid and to direct it to the discharge aperture; such that once the plurality of predetermined identifier labels are mixed with a base fluid to form a mixture, the mixture may be discharged through the discharge aperture.

Examples of some other or further embodiments may include embodiments or configurations: wherein the container is disposed to receive dynamic fluid; wherein the identifier labels are comprised of a DNA identifier; the base fluid is an adhesive; the base fluid is a paint; the base fluid includes DNA molecules;
the base fluid includes predetermined ultra violet detectable particles or molecules;
the dynamic fluid is air; and in which there is a dynamic fluid conduit disposed to deliver dynamic fluid to the container.

This invention further contemplates embodiments in which a mixture is created in the container, such as when the base fluid is mixed with the identifier labels in the container.

Other embodiments contemplated by the invention would include identifier label applicators for use in combination with a source of dynamic fluid, the applicator comprising: an applicator framework; a container operatively attached to the framework and including a plurality of predetermined identifier labels therein; a discharge aperture in fluid communication with the container such that it may receive identifier labels from the container; and a fluid intake aperture operative attached to the framework and configured to receive dynamic fluid and direct it to the discharge aperture; such that once the plurality of predetermined identifier labels are mixed with a base fluid to form a mixture, the mixture may be discharged through the discharge aperture.

This invention also contemplates method embodiments, for example a method for applying identifier labels to one or more articles, comprising the following steps: providing an identifier label container for use in combination with a source of dynamic fluid, the container comprising: a container with a plurality of predetermined identifier labels therein; a discharge aperture in fluid communication with the container; and a fluid intake aperture configured to receive the source of dynamic fluid and to direct it to the discharge aperture;
mixing the identifier labels with a base fluid to form a mixture
providing dynamic fluid through the discharge aperture; and thereby discharging the mixture through the discharge aperture.

A further method embodiment may further comprise the following steps of:
providing a dynamic fluid conduit disposed to deliver dynamic fluid to the container; and delivering dynamic fluid into the mixture, thereby causing movement of the mixture and a mixing of the base fluid and the identifier labels.

Examples of some other or further method embodiments may include embodiments or configurations: wherein the container is disposed to receive dynamic fluid; wherein the identifier labels are comprised of a DNA identifier; the base fluid is an adhesive; the base fluid is a paint; the base fluid includes DNA molecules; the base fluid includes predetermined ultra violet detectable particles or molecules; the dynamic fluid is air; and in which there is a dynamic fluid conduit disposed to deliver dynamic fluid to the container.

Yet another embodiment, a more autonomous or portable embodiment, is an identifier label container comprising: a container with an internal cavity in which there is a pressurized mixture of a plurality of predetermined identifier labels and a base fluid; a discharge aperture in fluid communication with the internal cavity of the container; and a container valve in fluid communication with the internal cavity and which is disposed to release the mixture from the internal cavity upon activation of the container valve to a desired location.

According to the present invention there is provided a method of applying microdots as identifier labels to an article, said method comprising: providing a container having a body containing a multiplicity of predetermined microdots therein and an adhesive into which the microdots are mixed, a discharge part coupled to the body and having a passage with an inlet portion and a discharge outlet, and a nozzle separately formed from the discharge part and adapted to be fitted into the discharge part; releasably fitting the nozzle onto an outlet component of a system for supplying air under pressure; feeding air under pressure via the nozzle and into the passage so that air flowing through the passage draws the mixture from the container body into the passage for discharge through the discharge part for application to the article; and removing the nozzle from the outlet component of the air supply system after use and disposing of the container, the discharge part, and the nozzle whereby the outlet component of the air supply system remains free from any contamination with the microdot/adhesive mixture and can thereby be used for a subsequent application without the need to clean it.

According to another aspect of the invention, there is provided a container assembly for use in the method defined above, the container assembly comprising a body containing a multiplicity of predetermined microdots and an adhesive into which the microdots are mixed, a discharge part coupled to the body and having a passage with an inlet portion and an discharge outlet, a draw tube leading from the mixture to the passage, and a nozzle separately formed from the discharge part and fitted into the passage in the discharge part such that air fed under pressure via the nozzle into the passage draws the mixture into the passage via the tube for discharge through the discharge part for application to the article.

Preferably the discharge part and the nozzle are each fabricated as separate one-piece plastics mouldings. Preferably the outlet component is an air gun having a discharge nozzle over which the inlet end of the first mentioned nozzle is releasably fitted.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1-23. (canceled)

24. A method of applying microdots as identifier labels to an article, said method comprising:
providing a container having a body containing a multiplicity of predetermined microdots therein and an adhesive into which the microdots are mixed, a discharge part coupled to the body and having a passage with an inlet portion and a discharge outlet, and a nozzle separately formed from the discharge part and adapted to be fitted into the passage in the discharge part;
releasably fitting the nozzle onto an outlet component of a system for supplying air under pressure;
feeding air under pressure via the nozzle and into the passage so that air flowing through the passage draws the mixture from the container body into the passage for discharge through the discharge part for application to the article; and
removing the nozzle from the outlet component of the air supply system after use and disposing of the container, the discharge part, and the nozzle whereby the outlet component of the air supply system remains free from any contamination with the microdot/adhesive mixture and can thereby be used for a subsequent application without the need to clean it.

25. A method according to claim 24, wherein the discharge part and the nozzle are each fabricated as separate one-piece plastics mouldings.

26. A method according to claim 24, wherein the nozzle is a friction fit in the passage.

27. A method according to claim 24, wherein the nozzle is a snap-fit in the passage.

28. A method according to claim 24, wherein the outlet component is an air gun having a discharge nozzle over which the inlet end of the first mentioned nozzle is releasably fitted.

29. A container assembly for use in connection with a method of applying microdots as identifier labels to an article, the container assembly comprising a body containing a plurality of predetermined microdots and an adhesive into which the microdots are mixed, a discharge part coupled to the body and having a passage with an inlet portion and an discharge outlet, a draw tube leading from the mixture to the passage, and a nozzle separately formed from the discharge part and fitted into the passage in the discharge part such that air fed under pressure via the nozzle into the passage draws the mixture into the passage via the tube for discharge through the discharge part for application to the article.

30. A container assembly according to claim 29, wherein the nozzle is a friction fit in the passage.

31. A container assembly according to claim 29, wherein the nozzle is a snap-fit in the passage.

32. A container assembly according to claim 29, wherein the discharge part and the nozzle are each fabricated as separate one-piece plastics moldings.

33. A method of applying microdots as identifier labels to an article, said method comprising providing a container having a body containing a plurality of predetermined microdots therein and a base fluid into which the microdots are mixed to form a mixture, said container also having a discharge part coupled to the body, said discharge part having a passage with an inlet portion and a discharge portion, the inlet portion being releasably coupled to a supply of dynamic fluid and the passage being in communication with the mixture, and feeding dynamic fluid from the supply through the passage so that the dynamic fluid flowing through the passage draws the mixture from the container body into the passage for discharge through the discharge portion for application to the article.

34. A method according to claim 33, wherein the mixture is applied to a single discrete article.

35. A method according to claim 34, comprising the steps of disconnecting the inlet portion of the container discharge part from the supply of dynamic fluid after application of the mixture to the single article, and disposing the container consisting of the body and the discharge part.

36. A method according to claim 33, wherein the labels are discrete to the particular article to which they are applied, and the container consisting of the body and discharge part is disposed after use whereby subsequent coupling of supply of dynamic fluid to the inlet portion of a further such container with discrete labels for application to a further article can be accomplished substantially without contamination with labels discrete to the first-mentioned article.

37. A method according to claim 35 or claim 36, wherein the discharge part of the container is releasably coupled to the container body and microdots are supplied in the body of the container.

38. A method according to claim 37, wherein the microdots and base fluid are supplied in the body of the container as a prepackaged mixture.

39. A method according to claim 37, wherein the microdots are supplied prepackaged in the container body and the base fluid is subsequently added prior to application.

40. A method according to claim 37, wherein the supply of dynamic fluid includes a structure from which the container is releasably supported, the structure including an activation device actuable to cause discharge of the dynamic fluid into the passage.

41. A method according to claim 40, comprising holding the structure in the hand to manipulate the container for discharge of the mixture from the discharge portion onto the article and actuating the activation device by means of the hand.

42. A method of applying microdots as discrete identifier labels to respective articles, said method comprising providing a first container having a body containing a plurality of predetermined microdots therein discrete to a first article and adhesive fluid into which the microdots are mixed to form a mixture, said container also having a discharge part coupled to the body, said discharge part having a passage with an inlet portion and a discharge portion, the passage being in communication with the mixture in the body, releasably coupling the inlet portion of the passage to the outlet of a supply of air as a dynamic fluid, feeding air through the passage from the air supply so that the air flowing through the passage causes the mixture to be displaced from the container body into the passage for discharge through the discharge portion for application to the first article, and when application to the first article has been completed, disconnecting the inlet portion of the discharge part from the air supply outlet and disposing of the first container consisting of body and discharge part of the second container to the said outlet of the air supply to discharge the mixture for application to the second article, and, when application to the second article has been completed, disconnecting the inlet portion of the discharge part, and providing a second like container having a body containing a plurality of a predetermined microdots therein discrete to a second article and adhesive fluid into which the microdots are mixed to form a mixture, releasably coupling the inlet portion of the discharge part of the second container from the air supply outlet and disposing of the container body and discharge part of the second container body, wherein application of the discrete microdots to the respective articles can be accomplished without contamination with microdots from a preceding application using the same air supply.

43. A method according to claim 42, wherein the air supply outlet is a part of a structure from which the container is releasably supported, the structure including a valve actuable to cause discharge of the air into the passage.

44. A method according to claim 42, comprising holding the structure in the hand so as to support and manipulate the container for application of the mixture to different parts of the article and operating the valve by means of the hand.
